(19) United States
(12) Patent Application Publication
(10) Pub. No.: US 2025/0347856 A1
(43) Pub. Date: Nov. 13, 2025

(54) OPTICAL ASSEMBLIES COMPRISING ADHESIVE CONFIGURED FOR HIGH TEMPERATURES

(71) Applicant: The Boeing Company, Arlington, VA (US)

(72) Inventors: Andrew P. Nowak, Winnetka, CA (US); Michael J. Ventuleth, Malibu, CA (US); Ashley M. Dustin, Santa Monica, CA (US); Adam E. Sorensen, Moorpark, CA (US); Kurt W. Loheit, Rolling Hills Estates, CA (US); Kenneth C. Widen, Topanga, CA (US); David C. Miccolis, Hawthorne, CA (US); Jennifer L. Ellis, Calabasas, CA (US)

(21) Appl. No.: 18/657,398

(22) Filed: May 7, 2024

(51) Int. Cl. G02B 6/38; C09J 5/06; C09J 133/02

(52) U.S. Cl. CPC G02B 6/3861; C09J 5/06; C09J 133/02; G02B 6/3853; G02B 6/3874

(57) ABSTRACT

An optical assembly as described herein may comprise a first optical component and a second optical component bonded to the first optical component with a phthalonitrile adhesive. The phthalonitrile adhesive is configured to withstand high temperatures with little or no effect on the alignment of the first and second optical components and/or the optical transmission between the first and second optical components. Methods of making an optical assembly may include bonding a first optical component to a second optical component using a phthalonitrile adhesive.

### FIELD

The present disclosure relates to optical assemblies in which components are bonded together by an adhesive that is configured to withstand high temperatures.

### BACKGROUND

Optical assemblies can be created by adhering optical components together using an adhesive. The adhesives that are conventionally used for this purpose (e.g., UV-curable acrylic and epoxy materials) set quickly, which is a useful quality during manufacture because the optical components in question need to be held in optical alignment as the adhesive sets. However, in many cases these adhesives have service temperatures no greater than approximately 150 degrees Celsius. Above their service temperatures, the adhesives may fail to maintain alignment between the optical components, thereby reducing or ruining the performance of the optical assembly. The service temperature of the adhesive thus limits the use temperature of the optical assembly. Accordingly, better solutions are needed for using adhesive to make optical assemblies that are suitable for high-temperature applications.

### SUMMARY

In some examples, a method of making an optical assembly comprises positioning a first optical component and a second optical component such that the first and second optical components are optically aligned and spaced from one another by a gap, and bonding the first and second optical components together by a phthalonitrile adhesive disposed at least partially within the gap.

In some examples, an assembly comprises a first optical component and a second optical component bonded to the first optical component with a phthalonitrile adhesive.

### BRIEF DESCRIPTION OF THE DRAWINGS

FIG. 1 is a schematic diagram depicting an illustrative optical assembly in accordance with aspects of the present teachings.

FIG. 2 is an isometric view depicting another illustrative optical assembly in accordance with aspects of the present teachings.

FIG. 3 is a side view of yet another illustrative optical assembly in accordance with aspects of the present teachings.

FIG. 4 is a side view of yet another illustrative optical assembly in accordance with aspects of the present teachings.

FIG. 5 is a schematic diagram depicting a portion of an illustrative method for making an optical assembly in accordance with aspects of the present teachings.

FIG. 6 is a schematic diagram depicting a portion of another illustrative method for making an optical assembly in accordance with aspects of the present teachings.

FIG. 7 is a flow chart depicting steps of yet another illustrative method for making an optical assembly in accordance with aspects of the present teachings.

### DESCRIPTION

In general, an optical assembly in accordance with aspects of the present teachings comprises at least a first element adhered to at least a second element by an adhesive comprising phthalonitrile resins or polymers. Each element may comprise one or more suitable optical components. The adhesive, referred to as a phthalonitrile adhesive, has superior thermo-oxidative stability compared to adhesives that are conventionally used in optical assemblies, such as epoxies. This allows the phthalonitrile adhesive to maintain alignment between the bonded elements of the optical assembly (e.g., without deforming or breaking) even at relatively high temperatures. For example, in some cases, the phthalonitrile adhesive can maintain alignment during continuous operation at temperatures of up to 350 degrees Celsius, and/or can maintain alignment during brief exposure to temperatures of up to 450 degrees Celsius. It is within the scope of the present disclosure that the service temperature of an optical assembly including a phthalonitrile adhesive be at least 100 degrees Celsius, 200 degrees Celsius, 250 degrees Celsius, 300 degrees Celsius, 350 degrees Celsius, 400 degrees Celsius, or higher.

In at least some examples, phthalonitrile adhesive is also configured to be rigid, in that it is stiff, non-deformable, and/or substantially lacking in flexibility under normal operating conditions for the optical assembly. The phthalonitrile adhesive may be configured to have a high resistance to mechanical stress over time, which allows it to continue to hold the optical assembly together even in settings including a large amount of mechanical stress (e.g., in the form of vibrations, jolts, and/or the like).

Furthermore, the phthalonitrile adhesive is able to transmit light having wavelength(s) within a wide wavelength range with little or no disruption to the light (e.g., without significantly attenuating the light, changing the polarization of the light, and/or otherwise affecting relevant characteristics of the light). Accordingly, the phthalonitrile adhesive can be disposed in an optical path of the optical assembly, such that light passes through the phthalonitrile adhesive during operation, without significantly impairing the performance of the optical assembly.

The suitability of phthalonitrile adhesives for high-temperature settings is known (see, e.g., U.S. Pat. Nos. 5,242,755A and 11,746,262B2, each of which is hereby incorporated by reference in its entirety for all purposes). However, phthalonitrile adhesives are not conventionally used in optical assemblies, because phthalonitrile adhesives have several properties that are conventionally regarded as unsuitable for optical assemblies. The curing time for phthalonitrile adhesives is relatively long, and it can be difficult or cumbersome to hold optical components in the correct positions relative to one another (e.g., in optical alignment) long enough for a phthalonitrile adhesive to set. Additionally, the melting temperature for phthalonitrile resins is typically high, and optical components tend to be easily damaged by high temperatures, which makes it difficult to bond optical components together with a phthalonitrile adhesive. Accordingly, conventional wisdom militates against attempting to use phthalonitrile adhesives in optical assemblies.

### Example Optical Assemblies

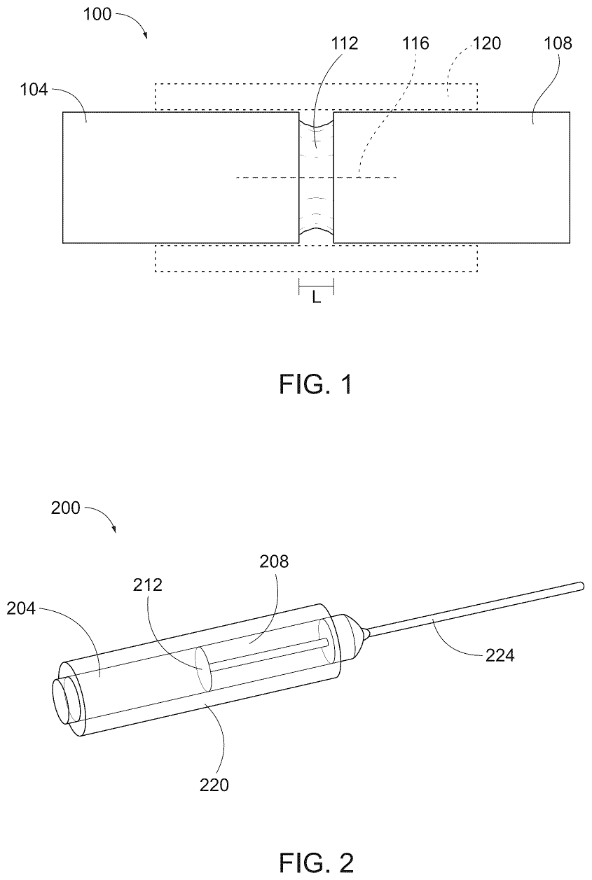

FIG. 1 is a schematic diagram depicting an illustrative optical assembly 100 in accordance with aspects of the present teachings. Generally, in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

Optical assembly 100 may also be referred to as a photonic assembly. Optical assembly 100 includes a first optical component 104 and a second optical component 108. First and second optical components 104, 108 are spaced from one another by a gap having length L. Suitable lengths L may include lengths in the range 1.5-2.0 millimeters, 1.0-1.5 millimeters, 0.5-1.0 millimeters, and/or any other suitable lengths. In some examples, depending on the particular adhesive composition and curing process being used, and on the optical properties of components 104, 108 and of the light passing therebetween, length L is in the range 0.75 to 1.25 millimeters (inclusive).

First and second optical components 104, 108 may each comprise one of the following, or a suitable combination thereof: a fiber optic connector (e.g., a ferrule connector, a fiber channel connector, a straight tip connector, an angled physical contact connector, and/or any other suitable device(s)); a gradient refractive index (GRIN) lens; a prism; a lens (e.g., a singlet lens, cylindrical lens, aspheric lens, achromatic lens, spherical lens, Fresnel lens, total internal reflectance (TIR) lens, and/or any other suitable lens(es)); a beamsplitter; a mirror; a neutral density filter; a spectral filter; a spatial filter; a waveplate; a window; a retroreflector; a grating; a diaphragm; a diffuser; a circulator; an isolator; a resonator; a cavity; a photonic integrated circuit; a pinhole; and/or any other suitable optical device(s). First and second optical components 104, 108 may comprise the same type(s) of optical device(s), different type(s) of optical device(s), or a combination of optical device(s) of the same type and optical device(s) of different types.

In examples in which first and/or second optical components 104, 108 terminate (or otherwise couple to) optical fiber(s), the optical fiber(s) may each be single mode or multimode and may be configured to transmit any suitable wavelength range. In some examples, a suitable wavelength range is 600 nanometers to 1600 nanometers; in some examples, a suitable wavelength range is 400 nanometers to 1700 nanometers. In general, any suitable wavelength range may be used, including wavelengths in the ultraviolet, near ultraviolet, visible, near infrared, short-wavelength infrared (including, e.g., telecom wavelengths), mid infrared, and/or any other suitable wavelength ranges. The optical fiber(s) may comprise conventional optical fiber, photonic crystal fiber, and/or any other suitable fiber(s). In some examples, first and/or second optical components 104, 108 terminate a bundle of fibers (e.g., six fibers, twelve fibers, and/or any other suitable number of fibers). In some examples, the optical fiber(s) are part of and/or coupled to a light-based sensor system, such as a radiation thermometer, chemical sensor, and/or any other suitable sensor system(s).

First and second optical components 104, 108 are disposed in optical alignment with one another, such that light can pass between them in a manner suitable for the particular optical components and intended use for any given example. For example, if components 104 and 108 are both fiber connectors terminating respective optical fibers, being in optical alignment means that that the connectors are positioned such that light can exit one fiber and enter the other with an efficiency high enough for the particular application. In some examples, being in optical alignment means that the two (or more) components share a common optical axis. Depending on the example, light may be able to pass from first optical component 104 to second optical component 108, from second optical component 108 to first optical component 104, or in either direction.

Optical components 104, 108 are bonded to one another by a phthalonitrile adhesive 112. Phthalonitrile adhesive 112 is an adhesive comprising one or more phthalonitrile resin(s) or polymer(s) and optionally one or more catalysts, additives, and/or other suitable constituent(s). In some examples, an amine catalyst and/or an organometallic catalyst is included.

In the depicted example, phthalonitrile adhesive 112 is disposed in an optical path 116 of light passing between first and second optical components 104, 108. Depending on the specific composition of phthalonitrile adhesive 112 in any particular example, the adhesive has a high optical transmission over wavelengths of interest (e.g., transmission of 50%, 60%, 70%, 80%, 90%, or more in the visible and/or near-infrared ranges), and imparts little to no change in polarization to light passing through the adhesive. In some examples, even if the transmissivity of the adhesive is relatively low at a given wavelength of interest, the thickness of the adhesive can be selected to be small enough that the overall loss of light passing through the adhesive is low enough that the optical assembly is suitable for its expected function(s). For instance, first and second optical components 104, 108 may be spaced from each other by a very small gap, such that the thickness of the adhesive in the gap is small enough that it absorbs an acceptably small fraction of the light passing through it.

In some examples, phthalonitrile adhesive 112 is not disposed in the optical path of light passing between optical components 104, 108. For example, the adhesive may be disposed on peripheral regions of optical components 104, 108, such that the optical path itself is free of adhesive. In yet other examples, the optical path is partly free of adhesive; for example, the adhesive can be positioned such that a portion of the light that passes between optical components 104, 108 does not pass through the adhesive, and another portion of the light does pass through the adhesive.

Optionally, first and second optical components 104, 108 are at least partially disposed in a mating sleeve 120. Mating sleeve 120 may comprise any suitable structure configured to help hold optical components 104, 108 in alignment with one another. For example, mating sleeve 120 may comprise a cylindrical tube made of glass, ceramic, metal, and/or any other suitable material(s). Alternatively, or additionally, mating sleeve 120 may comprise a fiber optic adapter specially configured to connect two fiber optic connectors to each other. Mating sleeve 120 may help to hold optical components 104, 108 in alignment as assembly 100 is being manufactured, and/or may help to protect the optical components and/or the adhesive from impacts, debris, moisture, corrosion, and/or stray light when assembly 100 is in use.

In some examples that include mating sleeve 120, phthalonitrile adhesive 112 bonds first and second optical components 104, 108 to the mating sleeve as well as to each other. In some examples that include mating sleeve 120, phthalonitrile adhesive 112 first and second optical components 104, 108 to the mating sleeve and does not bond the first and second optical components to each other; put another way, in such examples, components 104 and 108 are bonded directly to the mating sleeve but are not bonded directly to each other.

In some examples, first optical component 104 and/or second optical component 108 is adhered to a third optical component by a phthalonitrile adhesive, which may have the same composition or a different composition from the adhesive bonding component 104 and component 108 together. An example is discussed below with reference to FIG. 4.

Due at least in part to phthalonitrile adhesive 112 being rigid and resistant to heat, optical assembly 100 may be particularly suitable for use in aerospace, automotive, and/or manufacturing settings. For example, optical assembly 100 may be used in conjunction with a sensor in a high-temperature environment. However, in general optical assembly 100 may be deployed in any suitable setting for any suitable purpose.

FIGS. 2-4 depict illustrative non-exclusive examples of optical assembly 100. FIG. 2 is an isometric view depicting an illustrative assembly 200 comprising a GRIN lens 204 bonded to a fiber optic ferrule 208 by a phthalonitrile adhesive 212. More specifically, a substantially flat end of GRIN lens 204 is disposed adjacent a substantially flat end of ferrule 208, and phthalonitrile adhesive 212 is disposed between the flat end of the GRIN lens and the flat end of the ferrule.

In the example depicted in FIG. 2, a portion of GRIN lens 204 (including the flat end thereof), a portion of ferrule 208 (including the flat end thereof), and phthalonitrile adhesive 212 are disposed within a mating sleeve 220, which comprises a glass tube. In other examples, mating sleeve 220 may be omitted or may take a different form.

Ferrule 208 terminates an optical fiber 224, which in some examples is part of and/or coupled to a fiber optic sensor system. Assembly 200 is configured to allow light to pass between GRIN lens 204 and ferrule 208, through phthalonitrile adhesive 212. For example, light can enter assembly 200 through GRIN lens 204, pass through phthalonitrile adhesive 212 with minimal or no change, and enter fiber 224 through ferrule 208. Alternatively, or additionally, light can exit fiber 224 through ferrule 208, pass through phthalonitrile adhesive 212 with minimal or no change, and exit the assembly via GRIN lens 204.

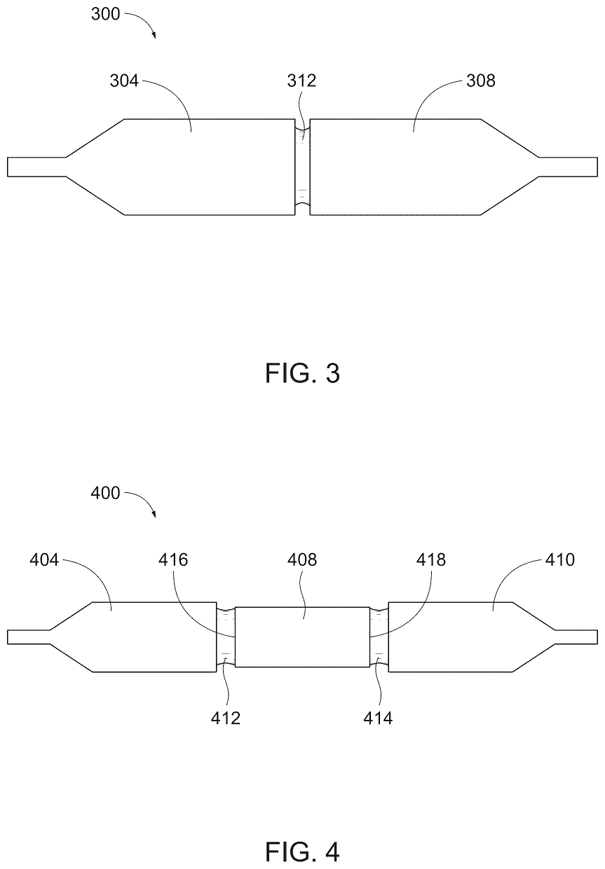

FIG. 3 is a side view depicting an illustrative assembly 300 comprising a first fiber optic ferrule 304 and a second fiber optic ferrule 308 disposed end-to-end and bonded to one another by a phthalonitrile adhesive 312. Light passing between ferrule 304 and ferrule 308 passes through phthalonitrile adhesive 312.

FIG. 4 is a side view depicting an illustrative assembly 400 comprising a first fiber optic ferrule 404, a GRIN lens 408, and a second fiber optic ferrule 410. First ferrule 404 is bonded to a first end 416 of GRIN lens 408 by phthalonitrile adhesive 412, and second ferrule 410 is bonded to a second end 418 of GRIN lens 408 by phthalonitrile adhesive 414. Accordingly, light can pass between first ferrule 404 and second ferrule 410 through GRIN lens 408 and also through phthalonitrile adhesives 412, 414. Phthalonitrile adhesive 412 may have the same composition as phthalonitrile adhesive 414, or a different composition. In some examples, phthalonitrile adhesives 412, 414 are from the same batch of phthalonitrile adhesive.

### Example Methods

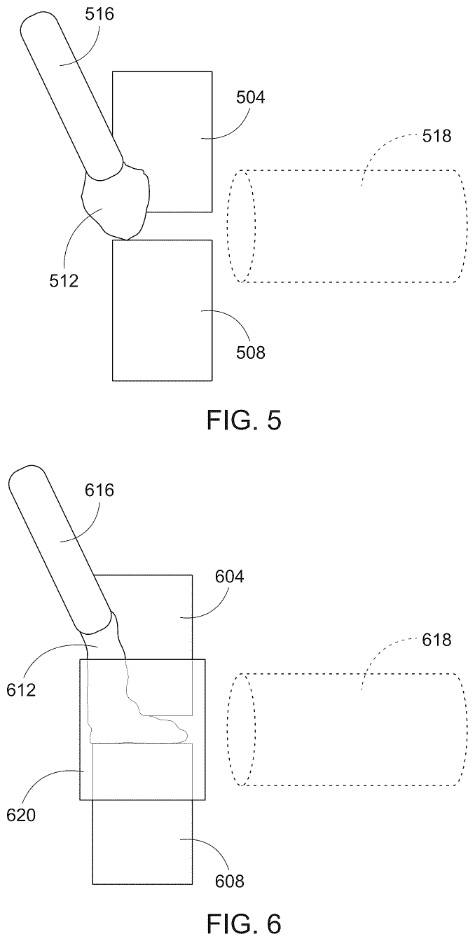

FIGS. 5-7 relate to processes for making an optical assembly using phthalonitrile adhesive, such as optical assembly 100, 200, 300, or 400. FIG. 5 is a schematic side view depicting a first optical component 504 being bonded to a second optical component 508 by a phthalonitrile adhesive 512. First and second optical components 504, 508 are disposed in optical alignment with one another, with first optical component 504 disposed vertically above second optical component 508.

An applicator 516 deposits adhesive 512 on first optical component 504. Adhesive 512 is not hardened at this point, and so the adhesive flows downward under the force of gravity into a gap between first optical component 504 and second optical component 508. In some examples, applicator 516 is moved to one or more additional angular positions around first optical component 504 so as to deposit adhesive 512 at different sides of component 504, such that the adhesive can flow into the gap from more than one direction. In some examples, adhesive 512 is applied such that it can flow into the gap from generally all directions (e.g., from 360 degrees around the perimeter of the gap).

For the application process depicted in FIG. 5, adhesive 512 is configured to flow at least partially into the gap between components 504, 508 such that it contacts both components 504, 508 and will, once set, bond the components to one another. For example, adhesive 512 may have a consistency, viscosity, temperature, and/or adhesion properties configured to enable the adhesive to flow at least partially into the gap in this manner (e.g., rather than running down the side of the optical components without entering the gap, entering the gap but only contacting one of the optical components, and/or otherwise failing to flow at least partially into the gap and contact both components).

Any suitable step(s) may be taken to cause adhesive 512 to be capable of flowing into the gap in the desired manner. For example, in some cases, a heat source 518 is used to heat adhesive 512 before and/or during application, such that the adhesive maintains the desired flow properties. In some examples, applicator 516 is dipped into a pool of molten adhesive 512, which begins to cool and solidify as it is transported by the applicator to the vicinity of first optical component 504, and heat source 518 re-melts the adhesive to facilitate transfer of the adhesive to component 504 and flow of the adhesive into the gap between components 504, 508. In some examples, heat source 518 is used to heat the adhesive before and/or during application and also to cure the adhesive after application.

Heat source 518 may comprise any heat source suitable for heating adhesive 512. For example, heat source 518 may comprise a portable rework station, a heat pen, a heat gun, a suitably dimensioned object heated to a high temperature such that it radiates a suitable amount of heat, and/or any other suitable device(s). In some examples, heat source 518 is configured to direct heat toward a relatively small spatial area, such that the heat source can heat adhesive 512 without significantly heating optical components 504, 508. In some examples, two or more heat sources 518 are provided, and they may be arranged so as to heat adhesive 512 from different angles. For example, in some cases, heat sources 518 are arranged facing each other on opposite sides of the assembly being manufactured.

FIG. 6 is a schematic side view depicting a first optical component 604 being bonded to a second optical component 608 by a phthalonitrile adhesive 612. The setup depicted in FIG. 6 is similar in many respects to that depicted in FIG. 5, and the description of FIG. 6 is therefore abbreviated accordingly. As depicted in FIG. 6, a phthalonitrile adhesive 612 is deposited on first optical component 604 by an applicator 616, and an optional heat source 618 heats the adhesive. In this example, portions of optical components 604, 608, and the gap between components 604, 608, are disposed in a mating sleeve 620. In the depicted example, the mating sleeve comprises a transparent material such as glass, but in general the mating sleeve may comprise any suitable material(s).

In the example depicted in FIG. 6, adhesive 612 is deposited by applicator 616 onto first optical component 604 and flows down component 604, into sleeve 620, and into the gap between components 604, 608. Adhesive 612 disposed within the gap between components 604 and 608 bonds components 604 and 608 to one another. Additionally, or alternatively, a sufficient amount of adhesive 612 may be allowed to solidify and set between first component 604 and the interior wall of sleeve 620 to enable adhesive 612 to bond component 604 to sleeve 620.

In some examples, second optical component 608 is bonded directly to mating sleeve 620 (e.g., instead of being bonded directly to first optical component 604, or in addition to being bonded directly to the first optical component). For example, adhesive may be deposited at the bottom edge of sleeve 620, such that capillary action draws the adhesive up between the interior wall of the sleeve and second component 608. Alternatively, or additionally, the assembly may be turned upside down, such that second optical component 608 is disposed vertically above first optical component 604, and adhesive 612 may be applied to the second component and allowed to flow down the second component into sleeve 620 to bond the second component to the sleeve. Accordingly, the two optical components may be bonded directly to each other, and/or to the mating sleeve.

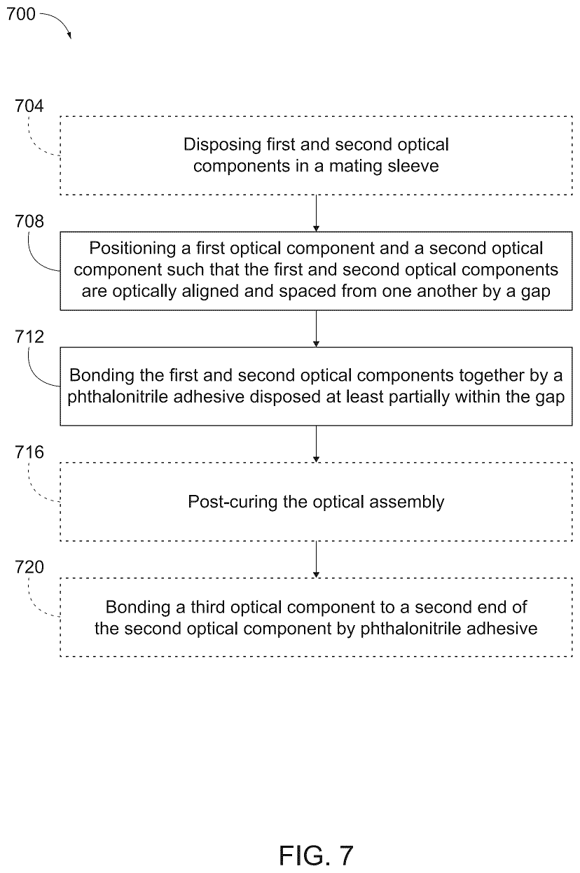

FIG. 7 is a flowchart depicting illustrative steps in an illustrative method 700 of making an optical assembly in accordance with aspects of the present teachings. In FIG. 7, some steps are illustrated in dashed boxes indicating that such steps may be optional or may correspond to an optional version of a method according to the present teachings. That said, not all methods according to aspects of the present teachings are required to include the steps illustrated in solid boxes. The method and steps illustrated in FIG. 7 are not limiting and other methods and steps are within the scope of the present disclosure, including methods having greater than or fewer than the number of steps illustrated, as understood from the descriptions herein.

At step 704, method 700 optionally includes disposing first and second optical components in a mating sleeve.

At step 708, method 700 includes positioning the first and second optical components such that the first and second optical components are optically aligned with one another and spaced from one another by a gap. In examples that include step 704, steps 704 and 708 may be performed in conjunction with one another; for example, disposing the first and second optical components in the sleeve may at least partially bring them into optical alignment with one another. The gap may have any suitable size, including, without limitation 2 millimeters, 1.5 millimeters, 1 millimeters, 0.5 millimeters, or any other suitable size. In some examples, the gap is in the range of 0.75 millimeters to 1.25 millimeters. The optical components may be positioned such that the size of the gap is determined with any suitable precision. Further examples related to step 708 are described below.

At step 712, method 700 includes bonding the first and second optical components together by a phthalonitrile adhesive, which is disposed at least partially within the gap. In some examples, the portion of the gap in which phthalonitrile adhesive is disposed includes at least a portion of the optical path between the two optical components, such that at least some light passing from component to component passes through the phthalonitrile adhesive.

In examples in which the first and second optical components are disposed in a mating sleeve, step 712 may be performed after the components have been placed in the sleeve, before the components are placed in the sleeve, or while one or both components are being placed in the sleeve.

In some examples, bonding the first and second optical components together includes applying the phthalonitrile adhesive to the first optical component and flowing the phthalonitrile adhesive into the gap, such that the phthalonitrile adhesive in the gap contacts both the first and second optical components. Flowing the phthalonitrile adhesive into the gap may include taking any suitable action(s) to cause at least a portion of the phthalonitrile adhesive to flow into the gap, including (but not limited to) applying the phthalonitrile adhesive to the first optical component such that it runs down the first optical component into the gap. Flowing the phthalonitrile adhesive into the gap between the first and second optical components may include flowing the phthalonitrile adhesive into an optical path between the first and second optical components.

In examples including the mating sleeve, bonding the first and second components together may include bonding each component to the mating sleeve rather than (or in addition to) bonding the two components directly to one another. For example, bonding the components together may include applying the phthalonitrile adhesive to the first optical component; flowing the phthalonitrile adhesive into a mating sleeve, such that the phthalonitrile adhesive bonds the first optical component to the mating sleeve; and bonding the mating sleeve to the second optical component. Additionally, or alternatively, bonding the components together may include applying the phthalonitrile adhesive to the second optical component and flowing the phthalonitrile adhesive into the mating sleeve, such that the phthalonitrile adhesive bonds the second optical component to the mating sleeve.

In some examples, bonding the first and second optical components together at step 712 includes heating the phthalonitrile adhesive using a heat source as the phthalonitrile adhesive is applied to the first optical component, such that the phthalonitrile adhesive remains able to flow under the force of gravity to bond the first optical component to the second optical component and/or to the sleeve. The phthalonitrile adhesive may have a relatively high melting temperature, e.g., a melting temperature higher than 100 degrees Celsius, 200 degrees Celsius, or 300 degrees Celsius. In some examples, two or more heat sources are used, and may be distributed about the assembly (e.g., uniformly) so as to provide symmetrical and/or relatively uniform heat.

In some examples, bonding the components together further includes curing the phthalonitrile adhesive using the same heat source used to heat the adhesive as it is applied. In other examples, however, a different or additional heat source might be used for curing, or no heat may be applied during curing. Whatever heat sources are used for curing may be set to any suitable temperature(s), which may include 200 degrees Celsius, 250 degrees Celsius, 300 degrees Celsius, 350 degrees Celsius, 400 degrees Celsius, 450 degrees Celsius, or in some cases higher. The adhesive may be cured for any suitable period of time, including in some cases longer periods of time than are used for conventional optical assembly adhesives. For example, the cure period may be 15 hours or more, and in some examples, 20 hours or more. In other examples, the cure period may be 14 hours, 13 hours, 12 hours, 11 hours, 10 hours, 9 hours, 8 hours, 7 hours, 6 hours, 5 hours, 4 hours, 3 hours, 2 hours, 1 hour, or any other suitable time period.

In some examples, positioning the first and second optical components comprises adjusting a relative position of the first and second optical components while the phthalonitrile adhesive cures within the gap. This may allow the optical alignment between the first and second optical components to be improved even as the adhesive cures. In some cases, it is possible that the application of the adhesive nudges the optical components out of alignment, and adjusting the relative position of the components after application and during the cure stage allows the components to be brought back into optical alignment.

At step 716, method 700 optionally includes post-curing the optical assembly. Post-curing the assembly may include placing the assembly at least partially in an oven. In some examples, the assembly is positioned such that the cured adhesive is disposed in the oven, but the first and second optical components are partly or entirely outside the oven. This may help prevent the optical components from sustaining damage or degradation due to the heat of the post-cure oven. The oven (or other post-cure heat source) may be set to any suitable temperature, in some cases at least 100 degrees Celsius, at least 200 degrees Celsius, at least 300 degrees Celsius, or at least 400 degrees Celsius. The post-cure period may have any suitable duration, including, e.g., 20 hours, 19 hours, 18 hours, 17 hours, 16 hours, 15 hours, 14 hours, 13 hours, 12 hours, 11 hours, 10 hours, 9 hours, 8 hours, 7 hours, 6 hours, 5 hours, 4 hours, 3 hours, 2 hours, 1 hour, or any other suitable duration.

At step 720, method 700 optionally includes bonding a third optical component to the second optical component using a second quantity of phthalonitrile adhesive. For example, the first optical component may be bonded to a first end of the second optical component, and at step 720 the third optical component may be bonded to a second end of the second optical component, such that all three optical components are in optical alignment with one another. The second quantity of phthalonitrile adhesive may have the same composition as the quantity used to bond the first and second optical components together, or a different composition. In some examples, four or more optical components are bonded together in optical alignment.

In some examples, method 700 includes, or is preceded by, preparing the phthalonitrile adhesive. Preparing the phthalonitrile adhesive may include heating the phthalonitrile resin until molten, mixing in a catalyst, optionally B-staging (reacting) the mixed resin and catalyst, and allowing the mixed resin and catalyst to cool. The adhesive may be mixed by hand, by overhead mixer, by centrifugal mixing, by vortexing, and/or in any other suitable way. In examples in which the adhesive is B-staged, it may be B-staged for 10 minutes, 20 minutes, 30 minutes, 60 minutes, 120 minutes, and/or any other suitable time period, and it may be B-staged at a temperature of at least 100 degrees Celsius, at least 200 degrees Celsius, at least 300 degrees Celsius, and/or any other suitable temperature(s).

### Example Alignment Methods

In some examples, aligning two optical components (e.g., at step 708 of method 700) includes directing a laser or other suitable light source into the first optical component, positioning the second optical component such that it collects light emitted from the first optical component, and adjusting the position of the second optical component to increase (in some cases, to maximize) the amount of light collected by the second optical component.

As an example, if the first and second optical components are fiber optic connectors terminating respective first and second optical fibers, aligning the optical components may include coupling a laser into the first fiber and free-space aligning the first and second optical components. For example, a laser may be coupled into the first end of the first optical fiber, such that light is emitted from the first optical component at the second end of the first optical fiber. The second optical component, which terminates a first end of the second optical fiber, can be placed in rough alignment with the first optical component. A photodiode or other suitable sensor at the second end of the second optical fiber senses an amount of laser light that is received at the second optical component and guided down the fiber to the second end. The position of the second optical component relative to the first optical component is adjusted to increase the amount of sensed light (e.g., to maximize the amount, or to achieve a threshold amount, etc.), thereby improving the alignment between the two optical components. The second optical component may be placed in a fiber optic alignment stage, which is used to precisely adjust the position of the second optical component; however, any suitable mechanism(s) for adjusting the position may be used. In some examples, the two optical components are placed in respective top and bottom mounts of a precision fiber optic alignment stage.

Adjusting the position of the second optical component relative to the first may include adjusting a distance between the components, e.g., adjusting a position of the second optical component in a Z-direction defined by (or parallel to) the optical axis of the first component, and then adjusting the position of the second component in X- and/or Y-directions orthogonal to the Z-direction to increase the amount of light transmitted through the second component. This process may be performed iteratively to “walk” the second optical component toward the first optical component until the two components are aligned with each other at a distance suitable for bonding (e.g., around 1 millimeter apart, and/or any other suitable distance). For example, the process may include bringing the second optical component to a first Z position, adjusting the position of the second optical component in the X-Y plane to maximize and/or increase the amount of light transmitted through the second optical component, then adjusting the Z position to bring the second optical component closer to the first, and adjusting the X-Y position to increase the amount of transmitted light again, and so on. The first Z position may be relatively far from the first optical component, e.g., 1 centimeter away.

Adjusting the position of the second optical component may additionally or alternatively include adjusting an angular position of the second optical component relative to the first optical component. In some examples, aligning the first and second optical components includes adjusting the position of the first optical component instead of (or in addition to) the position of the second optical component. In examples in which the first and second optical components are fiber connectors and aligning the components includes coupling light between the components (e.g., as described above), the first and second optical components may be arranged vertically, with one positioned above the other. The laser may be coupled into the upper fiber and the photodiode arranged at the end of the lower fiber, or vice versa. Aligning the components while they are disposed vertically one on top of the other may facilitate bonding the components together by applying an adhesive to the upper component and flowing it into the gap between components, as described elsewhere herein. However, it is also contemplated that the components could be arranged horizontally during alignment (e.g., with the adhesive being applied to the horizontal components, or with the components being moved into a vertical configuration before the adhesive is applied), or arranged in any other suitable manner.

The fiber connectors in such examples may or may not be disposed within a mating sleeve. A mating sleeve may help to bring the connectors into approximate optical alignment. Typically, further adjustment is needed to improve the alignment between the connectors such that light can be transferred between them with adequate efficiency.

### Example Results

For illustration, non-limiting examples of processes actually carried out for making an optical assembly are described here.

In a first illustrative example, a phthalonitrile adhesive was prepared by adding 2.0 grams of bisphenol A oligomeric phthalonitrile composition (Bis A PEEK PN) containing n repeat units of 1.5 (n=1.5), and 0.06 g of a bis [4-(3-aminophenoxy)phenyl]sulfone (m-BAPS), to an aluminum weigh boat. The boat was placed in a 200 degree Celsius oven for 10 minutes to allow the solids to melt. The solution was stirred while hot to homogenize the resin and catalyst. The weigh boat was returned to the oven for 60 additional minutes before being removed and allowed to cool into a frangible solid.

An aluminum weigh boat of the prepared phthalonitrile adhesive was reheated on a hot plate at 200 degrees Celsius until molten. A small metal applicator was dipped into the molten adhesive and a small amount of the adhesive was drawn up and allowed to cool. Two SMF-28 pigtailed ferrules were placed in respective top and bottom mounts of a precision optical stage and aligned, with one ferrule facing up and the other disposed over the first ferrule facing down. Two portable rework stations were attached to ring stands and pointed directly at the aligned ferrules. The rework stations were powered on and set to 275 degrees Celsius. The resin tipped applicator was placed in front of the rework station to re-melt the adhesive. The adhesive was then applied onto the top ferrule and allowed to run into the gap between the two ferrules. The ferrules were re-aligned as necessary using the micrometer knobs on the alignment stage during the first hour of the cure. The setup was allowed to cure for five hours before the portable rework stations were powered off and the bonded setup allowed to cool to room temperature.

In a second illustrative example, 2.0 g of Bis A PEEK PN (n=5) and 0.06 g of m-BAPS were added to an aluminum weigh boat. The boat was placed in a 200 degree Celsius oven for 10 minutes to allow the solids to melt. The solution was stirred while hot to homogenize the resin and catalyst. The resin and catalyst mixture was allowed to cool into a frangible solid. An aluminum weigh boat of the prepared phthalonitrile adhesive was reheated on a hot plate at 200 degrees Celsius until molten. A small metal applicator was dipped into the molten adhesive and a small amount of adhesive was drawn up and allowed to cool. One portable rework station was attached to a ring stand and pointed directly at two optical coherence tomography (OCT) fiber probes that had been aligned in a glass mating sleeve. The rework station was powered on and set to 300 degrees Celsius. The resin-tipped applicator was placed in front of the rework station to re-melt the adhesive. The adhesive was applied around the top edge of the sleeve. Additional resin was drawn up and applied to the bottom edge of the glass sleeve. Capillary action spread the adhesive into the sleeve creating a bond with both the top and bottom OCT fiber probes. The adhesive was allowed to cure for one hour in which the alignment was monitored and adjusted via micrometer knobs on the alignment stage. The adhesive was allowed to cure for an additional two hours before the portable rework station was turned off. After sitting overnight, the rework station was again powered on and set to 300 degrees Celsius. The adhesive was cured for an additional nine hours before the rework station was powered off and the bonded setup was allowed to cool to room temperature.

In a third illustrative example, 2.0 g of Bis A PEEK PN (n=5) and 0.06 g of m-BAPS were added to an aluminum weigh boat. The boat was placed in a 200 degree Celsius oven for 10 minutes to allow the solids to melt. The solution was stirred while hot to homogenize the resin and catalyst. The resin and catalyst mixture was allowed to cool into a frangible solid. The adhesive was reheated on a hot plate at 250 degrees Celsius until molten. A small metal applicator was dipped into the molten adhesive and a small amount of adhesive was drawn up and allowed to cool. A pigtailed ferrule was placed in the bottom mount of a precision fiber optic alignment stage. A GRIN lens was placed in the top mount of the stage. The ferrule and GRIN lens were then brought together using the micrometer controls until they were almost touching. The x-y position of the two components were aligned by sight. The lens was raised along the z-axis until separated from the ferrule by roughly 10 mm. Two portable rework stations were attached to ring stands and pointed directly at the ferrule and GRIN lens on the alignment stage. The rework stations were powered on and set to 300 degrees Celsius. The resin tipped applicator was placed in front of the rework stations to re-melt the adhesive. The adhesive was applied to the ferrule and the GRIN lens was lowered along the z-axis into the adhesive. The adhesive was allowed to cure for three hours. The bonded setup was removed from the alignment stage and re-attached into the top mount with the free GRIN face (unbound) facing down. A new pigtailed ferrule was placed in the bottom mount and the bonding process was repeated again for the second bond. After curing, the ferrule-GRIN-ferrule bonded setup was allowed to cool before removing from the alignment stage. The bonded portions of the setup were carefully placed in an oven with the pigtailed ends remaining outside, and allowed to post-cure for 16 hours at 200 degrees Celsius.

### Enumerated Paragraphs

Illustrative, non-exclusive examples of inventive subject matter according to the present disclosure are described in the following enumerated paragraphs:
A1. A method of making an optical assembly, the method comprising:
positioning a first optical component and a second optical component such that the first and second optical components are optically aligned and spaced from one another by a gap; and
bonding the first and second optical components together by a phthalonitrile adhesive disposed at least partially within the gap.
A1.1. The method of paragraph A1, wherein bonding the first and second optical components together by the phthalonitrile adhesive comprises applying the phthalonitrile adhesive to the first optical component and flowing the phthalonitrile adhesive into the gap, such that the phthalonitrile adhesive in the gap contacts the first and second optical components.
A1.1.1. The method of paragraph A1.1, wherein the first and second optical components are disposed in a mating sleeve when the phthalonitrile adhesive is applied to the first optical component.
A1.1.1.1. The method of paragraph A1.1.1, further comprising prior to applying, disposing the first and second optical components in the mating sleeve.
A1.1.2. The method of any one of paragraphs A1.1-A1.1.1.1, wherein bonding the first and second optical components together further comprises heating the phthalonitrile adhesive using a heat source as the phthalonitrile adhesive is applied to the first optical component.
A1.1.2.1. The method of paragraph A1.1.2, wherein bonding the first and second optical components together further comprises curing the phthalonitrile adhesive using the heat source.
A1.1.3. The method of any one of paragraphs A1.1-A1.1.2.1, wherein flowing the phthalonitrile adhesive into the gap between the first and second optical components comprises flowing the phthalonitrile adhesive into an optical path between the first and second optical components.
A1.2. The method of paragraph A1, wherein bonding the first and second optical components together by the phthalonitrile adhesive comprises: applying the phthalonitrile adhesive to the first optical component; flowing the phthalonitrile adhesive into a mating sleeve, such that the phthalonitrile adhesive bonds the first optical component to the mating sleeve; and bonding the mating sleeve to the second optical component.
A1.2.1. The method of paragraph A1.2, wherein bonding the mating sleeve to the second optical component comprises: applying the phthalonitrile adhesive to the second optical component and flowing the phthalonitrile adhesive into the mating sleeve, such that the phthalonitrile adhesive bonds the second optical component to the mating sleeve.
A1.2.2. The method of any one of paragraphs A1.2-A1.2.1, wherein an optical path between the first and second optical components passes through the phthalonitrile adhesive.
A2. The method of any one of paragraphs A-A1.1.3, wherein positioning the first and second optical components comprises adjusting a relative position of the first and second optical components while the phthalonitrile adhesive cures within the gap.
A3. The method of any one of paragraphs A-A2, wherein the first optical component comprises a fiber optic connector terminating an optical fiber.
A3.1. The method of paragraph A3, wherein the fiber optic connector comprises a ferrule connector, a fiber channel connector, a straight tip connector, an angled physical contact connector, or a combination thereof.
A3.2. The method of any one of paragraphs A3-A3.1, wherein the optical fiber is configured to transmit light of a wavelength within a range of 400 nanometers to 1700 nanometers.
A4. The method of any one of paragraphs A1-A2.2, wherein the phthalonitrile adhesive has a melting temperature higher than 200 degrees Celsius.
A5. The method of any one of paragraphs A-A4, wherein bonding the first and second optical components together by the phthalonitrile adhesive comprises curing the phthalonitrile adhesive for at least fifteen hours.
A6. The method of any one of paragraphs A-A5, further comprising post-curing the optical assembly.
A7 The method of any one of paragraphs A-A6, wherein the second optical component has a first end and a second end, and wherein bonding the first and second optical components together by the phthalonitrile adhesive comprises bonding the first optical component to the first end of the second optical component by the phthalonitrile adhesive, the method further comprising:
bonding a third optical component to the second end of the second optical component by a second phthalonitrile adhesive.
A8. The method of any one of paragraphs A1-A7, further comprising preparing the phthalonitrile adhesive.
A9. The method of any one of paragraphs A1-A8, wherein the phthalonitrile adhesive comprises one or more of the following; a bisphenol A oligomeric phthalonitrile composition (Bis A PEEK PN) containing n repeat units of 1.5; a bisphenol A oligomeric phthalonitrile composition (Bis A PEEK PN) containing n repeat units of 5; a bis [4-(3-aminophenoxy)phenyl]sulfone (m-BAPS).
A10. An optical assembly made according to the method of any one of paragraphs A1-A9.
B1. An assembly comprising:
a first optical component; and
a second optical component bonded to the first optical component with a phthalonitrile adhesive.
B1.1. The assembly of paragraph B1, wherein the phthalonitrile adhesive is disposed in an optical path between the first and second optical components.
B1.2. The assembly of any one of paragraphs B1-B1.1, wherein the first and second optical components are disposed in a mating sleeve.
B2. The assembly of any one of paragraphs B1-B1.2, wherein the first optical component is a ferrule terminating an optical fiber.
B2.1. The assembly of paragraph B2, wherein the second optical component is a gradient-index (GRIN) lens.
B2.2. The assembly of paragraph B2, wherein the second optical component is a second ferrule terminating a second optical fiber.
C1. The use of the assembly of any one of paragraphs A10-B2.2 to transmit and/or reflect light.
D1. A method of creating an aligned optical assembly, the method comprising:
a) preparing a phthalonitrile adhesive;
b) aligning a fiber optic pigtail and a second optical component;
c) bonding the fiber optic pigtail and the second optical component using the phthalontrile adhesive;
d) optionally, aligning the bonded fiber optic pigtail and the second optical component to a third optical component, and bonding the second optical component to the third optical component using a phthalonitrile adhesive; and
f) optionally, post-curing the bonded optical assembly.
E1. A method of creating an optical assembly, the method comprising:
heating a phthalonitrile adhesive until molten;
dipping an applicator into the molten adhesive and allowing the adhesive on the applicator to cool;
aligning first and second optical components with each other;
directing a portable rework station at the aligned optical components;
positioning the applicator adjacent the aligned optical components such that heat from the portable rework station melts the adhesive;
applying the adhesive to the first optical component and allowing it to run into a gap between the first and second optical components;
curing the adhesive that bonds the first and second optical components, for a first cure period, using heat from the portable rework station;
optionally, realigning the first and second optical components during the first cure period;
removing or turning off the portable rework station and allowing the adhesive that bonds the first and second optical components to cool to ambient temperature.
E2. The method of paragraph E1, wherein aligning the first and second optical components includes placing the first and second optical components in a mating sleeve.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, terms such as “first”, “second”, and “third” are intended to distinguish or identify various members of a group, or the like, and are not intended to show serial or numerical limitation.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A method of making an optical assembly, the method comprising:
positioning a first optical component and a second optical component such that the first and second optical components are optically aligned and spaced from one another by a gap; and
bonding the first and second optical components together by a phthalonitrile adhesive disposed at least partially within the gap.

2. The method of claim 1, wherein bonding the first and second optical components together by the phthalonitrile adhesive comprises applying the phthalonitrile adhesive to the first optical component and flowing the phthalonitrile adhesive into the gap, such that the phthalonitrile adhesive in the gap contacts the first and second optical components.

3. The method of claim 2, wherein the first and second optical components are disposed in a mating sleeve when the phthalonitrile adhesive is applied to the first optical component.

4. The method of claim 2, wherein bonding the first and second optical components together further comprises heating the phthalonitrile adhesive using a heat source as the phthalonitrile adhesive is applied to the first optical component.

5. The method of claim 4, wherein bonding the first and second optical components together further comprises curing the phthalonitrile adhesive using the heat source.

6. The method of claim 2, wherein flowing the phthalonitrile adhesive into the gap between the first and second optical components comprises flowing the phthalonitrile adhesive into an optical path between the first and second optical components.

7. The method of claim 1, wherein bonding the first and second optical components together by the phthalonitrile adhesive comprises: applying the phthalonitrile adhesive to the first optical component; flowing the phthalonitrile adhesive into a mating sleeve, such that the phthalonitrile adhesive bonds the first optical component to the mating sleeve; and bonding the mating sleeve to the second optical component.

8. The method of claim 7, wherein bonding the mating sleeve to the second optical component comprises: applying the phthalonitrile adhesive to the second optical component and flowing the phthalonitrile adhesive into the mating sleeve, such that the phthalonitrile adhesive bonds the second optical component to the mating sleeve.

9. The method of claim 7, wherein an optical path between the first and second optical components passes through the phthalonitrile adhesive.

10. The method of claim 1, wherein positioning the first and second optical components comprises adjusting a relative position of the first and second optical components while the phthalonitrile adhesive cures within the gap.

11. The method of claim 1, wherein the first optical component comprises a fiber optic connector terminating an optical fiber.

12. The method of claim 1, wherein the phthalonitrile adhesive has a melting temperature higher than 200 degrees Celsius.

13. The method of claim 1, wherein bonding the first and second optical components together by the phthalonitrile adhesive comprises curing the phthalonitrile adhesive for at least fifteen hours.

14. The method of claim 1, wherein the second optical component has a first end and a second end, and wherein bonding the first and second optical components together by the phthalonitrile adhesive comprises bonding the first optical component to the first end of the second optical component by the phthalonitrile adhesive, the method further comprising:
bonding a third optical component to the second end of the second optical component by a second phthalonitrile adhesive.

15. An assembly comprising:
a first optical component; and
a second optical component bonded to the first optical component with a phthalonitrile adhesive.

16. The assembly of claim 15, wherein the phthalonitrile adhesive is disposed in an optical path between the first and second optical components.

17. The assembly of claim 16, wherein the first and second optical components are disposed in a mating sleeve.

18. The assembly of claim 16, wherein the first optical component is a ferrule terminating an optical fiber.

19. The assembly of claim 18, wherein the second optical component is a gradient-index (GRIN) lens.

20. The assembly of claim 18, wherein the second optical component is a second ferrule terminating a second optical fiber.
